(19) United States
(12) Patent Application Publication
(10) Pub. No.: US 2026/0181296 A1
(43) Pub. Date: Jun. 25, 2026

(54) ELECTRONIC DEVICE AND OPERATING METHOD FOR ELECTRONIC DEVICE

(71) Applicant: SAMSUNG ELECTRONICS CO., LTD., Suwon-si (KR)

(72) Inventors: Yeongjun KWON, Suwon-si (KR); Beomsoo KIM, Suwon-si (KR); Hyeonggwon KIM, Suwon-si (KR); Kyeong NAMKOONG, Suwon-si (KR); Minjae SHIN, Suwon-si (KR)

(73) Assignee: SAMSUNG ELECTRONICS CO., LTD., Suwon-si (KR)

(21) Appl. No.: 19/541,767

(22) Filed: Feb. 17, 2026

Related U.S. Application Data
(63) Continuation of application No. PCT/KR2024/010954, filed on Jul. 26, 2024.

(30) Foreign Application Priority Data
Sep. 6, 2023 (KR) 10-2023-0118523

(51) Int. Cl. H04R 1/02

(52) U.S. Cl. CPC H04R 1/026

(57) ABSTRACT

An operating method of an electronic device connected to a plurality of display devices, includes identifying that an extended display function of at least two devices among a plurality of display devices and the electronic device is activated, identifying a volatility value for each device of the at least two devices based on an input signal input to the electronic device, increasing the sound intensities of speakers of a first device having the greatest variability value among the at least two devices, and increasing the sound intensity of a speaker adjacent to the first device. The volatility value indicates the degree of change in the screens of the at least two devices.

### CROSS-REFERENCE TO RELATED APPLICATIONS

This application is a continuation of International Application No. PCT/KR2024/010954, filed on Jul. 26, 2024, which is based on and claims priority to Korean Patent Application No. 10-2023-0118523, filed on Sep. 6, 2023, in the Korean Ministry of Intellectual Property, the disclosures of which are incorporated by reference herein in their entireties.

### BACKGROUND

### 1. Field

The disclosure relates to an electronic device and a method of operating the electronic device.

### 2. Description of Related Art

Three-dimensional (3D) stereophonic sound is a sound output method that utilizes differences in arrival time and sound intensity between a microphone and a sound source during sound recording, and generates a spatial audio effect by combining various sound sources for output or by specifying physical positions of speakers and assigning corresponding sound sources to those positions. 3D stereophonic sound implementation methods include channel-based implementation methods and object-based implementation methods. The channel-based implementation method is a method for implementing stereophonic sound using speaker systems, which may be configured as mono (1 channel), stereo (2 channels), 5.1 channels, 7.1 channels, or 9.1 channels. In a channel-based method, implementation of stereophonic sound requires that a consumer use audio equipment compliant with corresponding channel-based specifications and arrange the equipment in designated positions, and that sound sources supporting those specifications be used. The object-based implementation method treats audio signals as individual objects, to which position information and acoustic characteristics are assigned, and renders the audio objects independently of a specific speaker system. In an object-based method, stereophonic sound may be experienced using simple 2-channel stereo equipment; however, generation of sound sources may require a supplier to use dedicated equipment, such as dummy head microphones.

### SUMMARY

According to an aspect of the disclosure, a method of operating an electronic device connected to a plurality of display devices may be provided. The method may include identifying that an extended display function of at least two devices among the plurality of display devices and the electronic device is activated, identifying a volatility value for each device of the at least two devices based on an input signal input to the electronic device, increasing a sound intensity of speakers of a first device having a largest volatility value among the at least two devices, and increasing a sound intensity of a speaker disposed adjacent to the first device. Each volatility value for each device of the at least two devices may indicate a degree of a screen change of the device.

The speaker disposed adjacent to the first device is disposed on a first side surface of a second device among the at least two devices, and the first side surface of the second device includes a surface facing the first device.

Speakers positioned in a first direction from a central point among speakers of the at least two devices are configured to output sound corresponding to a left channel of the input signal, and speakers positioned in a second direction opposite to the first direction from the central point among the speakers of the at least two devices are configured to output sound corresponding to a right channel of the input signal, and wherein the central point includes a central point of the at least two devices.

The sound intensity of the speakers of the first device is increased by a first value, the sound intensity of the speaker disposed adjacent to the first device is increased by a second value, and the first value is greater than the second value.

The identifying that the extended display function of at least two devices among the plurality of display devices and the electronic device is activated includes identifying that each of the at least two devices are physically connected through at least one hinge; and based on the identifying that each of the at least two devices are physically connected through the at least one hinge, identifying that the extended display function of the at least two devices is activated.

The method may further include identifying frames of a screen displayed on the at least two devices, and measuring a difference in pixel values of the frames.

The identifying the volatility value for each device of the at least two devices is based on an area where an object displayed on a screen of the at least two devices is positioned.

The increasing the sound intensity of the speakers of the first device includes increasing a sound intensity of a speaker among the speakers of the first device corresponding to the area where the object is positioned.

The method may further include identifying a display mode of each of the plurality of display devices, the display mode indicating an extended display mode or a standalone display mode, the extended display function being indicative of the extended display mode, and based on the identifying the display mode of each of the plurality of display devices, controlling each display device of the plurality of display devices to output sound based on a single input source or a different type of input source.

The method may further include comparing the volatility value of each device of the at least two devices, and based on the comparing the volatility value of each device of the at least two devices, identifying the first device having the largest volatility value.

According to an aspect of the disclosure, an electronic device connected to a plurality of display devices may include at least two speakers, memory storing instructions, and at least one processor connected to the at least two speakers. The instructions, when executed by the at least one processor individually or collectively, cause the electronic device to identify that at least two devices among the plurality of display devices and the electronic device are in an extended display mode, identify a volatility value for each device of the at least two devices based on an image signal input to the electronic device, increase a sound intensity of speakers of a first device having a largest volatility value among the at least two devices, and increase a sound intensity of a speaker disposed adjacent to the first device. Each volatility value for each device of the at least two devices indicates a degree of a screen change of the device.

The speaker disposed adjacent to the first device is disposed on a first side surface of a second device among the at least two devices, and the first side surface of the second device is a surface facing the first device.

Speakers positioned in a first direction from a central point among speakers of the at least two devices are configured to output sound corresponding to a left channel of the input signal, and wherein the central point includes a central point of the at least two devices.

Speakers positioned in a second direction opposite to the first direction from the central point among the speakers of the at least two devices are configured to output sound corresponding to a right channel of the input signal.

The sound intensity of the speakers of the first device is increased by a first value, the sound intensity of the speaker disposed adjacent to the first device is increased by a second value, and the first value is greater than the second value.

The electronic device may further include a connector connected to the at least one processor. The instructions, when executed by the at least one processor individually or collectively, cause the electronic device to identify that each device of the at least two devices are physically connected through at least one hinge, and based on each device of the at least two devices being physically connected through the at least one hinge, identify that the extended display function of the at least two devices is activated.

The instructions, when executed by the at least one processor individually or collectively, cause the electronic device to identify frames of a screen displayed on the at least two devices, and measure a difference in pixel values of the frames.

The instructions, when executed by the at least one processor individually or collectively, cause the electronic device to identify an area where an object displayed on a screen of the at least two devices is positioned, and increase a sound intensity of a speaker among the speakers of the first device corresponding to the area where the object is positioned.

The identifying the volatility value for each device of the at least two devices includes identifying a refresh rate and a frame rate of each device of the at least two devices.

The instructions, when executed by the at least one processor individually or collectively, cause the electronic device to compare the volatility value of each device of the at least two devices, and based on the volatility value of each device of the at least two devices being compared, identify the first device having the largest volatility value.

According to an aspect of the disclosure, a non-transitory computer-readable storage medium having stored thereon instructions that, when executed by at least one processor of an electronic device, cause the electronic device to identify that at least two devices among a plurality of display devices and the electronic device are in an extended display mode, identify a volatility value for each device of the at least two devices based on an image signal input to the electronic device, increase sound intensity of speakers of a first device having a largest volatility value among the at least two devices; and increase sound intensity of a speaker disposed adjacent to the first device. Each volatility value for each device of the at least two devices indicates a degree of a screen change of the device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to one or more embodiments;

FIG. 2 illustrates an example of a connection structure of the display devices according to one or more embodiments;

FIG. 3A illustrates an example of a connection structure of the display devices according to one or more embodiments;

FIG. 3B illustrates an example of a connection structure of the display devices according to one or more embodiments;

FIG. 4A illustrates an example of a connection structure between an external electronic device and display devices according to one or more embodiments;

FIG. 4B illustrates an example of a connection structure between an external electronic device and display devices according to one or more embodiments;

FIG. 5A illustrates an example of a connection structure of the display devices according to one or more embodiments;

FIG. 5B illustrates an example of a connection structure of the display devices according to one or more embodiments;

FIG. 5C illustrates an example of a connection structure between a display device and a server according to one or more embodiments;

FIG. 5D illustrates an example of a connection structure between a display device and an external electronic device according to one or more embodiments;

FIG. 6 illustrates an operation flow of an electronic device according to one or more embodiments;

FIG. 7 illustrates an example of sound control of a display device according to one or more embodiments;

FIG. 8 illustrates an operation flow of an electronic device according to one or more embodiments;

FIG. 9A illustrates an example of sound output control according to an area where an object of an electronic device is positioned according to one or more embodiments;

FIG. 9B illustrates an example of sound output control according to an area where an object of an electronic device is positioned according to one or more embodiments;

FIG. 9C illustrates an example of sound output control according to an area where an object of an electronic device is positioned according to one or more embodiments;

FIG. 9D illustrates an example of sound output control according to an area where an object of an electronic device is positioned according to one or more embodiments;

FIG. 9E illustrates an example of sound output control according to an area where an object of an electronic device is positioned according to one or more embodiments; and

FIG. 9F illustrates an example of sound output control according to an area where an object of an electronic device is positioned according to one or more embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

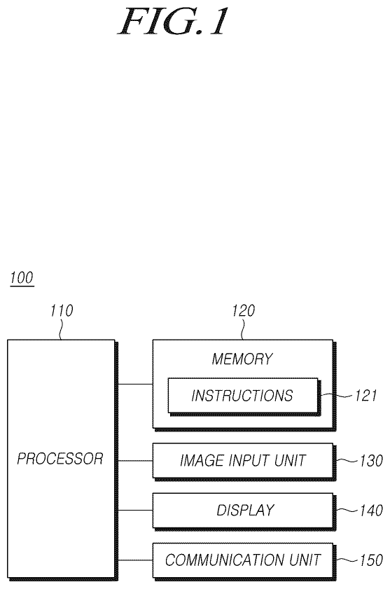

FIG. 1 is a block diagram illustrating a configuration of an electronic device according to one or more embodiments. The electronic device 100 may be a wearable terminal, such as watches and glasses, capable of performing various computing functions, such as video playback and communication. The electronic device 100 may be various types of terminals and embodiments of the disclosure not limited to the above examples.

According to one or more embodiments, the memory 120 is a storage medium used by the electronic device 100 and may store data, such as at least one instruction 121 (e.g., at least one command) or configuration information corresponding to at least one program. The program may include an operating system (OS) program and various application programs.

In one or more embodiments, the memory 120 may store pairing information about an external electronic device located adjacent to the electronic device 100. In one or more embodiments, the pairing information may include, e.g., device information about the external electronic device, information about another external electronic device or remote control device paired with the external electronic device, information about a scheme (e.g., Bluetooth or Wi-Fi) in which the external electronic device and the other external electronic device or remote control device are paired with each other, and information about a pairing history between the external electronic device and the other external electronic device or remote control device.

In one or more embodiments, the memory 120 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to one or more embodiments, the image input unit 130 may receive images and image information through a tuner, an input/output unit, or the communication unit 150. The image input unit 130 may include at least one of the tuner and the input/output unit. The tuner may tune and select only the frequency of the broadcast channel to be received by the electronic device 100 from among many radio wave components through amplification, mixing, resonance, or the like for the broadcast signal wiredly/wirelessly received. The broadcast signal may include video, audio, and additional data (e.g., electronic program guide (EPG)). The tuner may receive real-time broadcast channels (or real-time viewing images) from various broadcast sources, such as terrestrial broadcasts, cable broadcasts, satellite broadcasts, Internet broadcasts, and the like. The tuner may be implemented integrally with the electronic device 100 or may be implemented as a separate tuner electrically connected to the electronic device 100. The input/output unit may include at least one of a high definition multimedia interface (HDMI) input port, a component input jack, a PC input port, and a USB input jack capable of receiving an image and image information from an external device of the electronic device 100 under the control of the processor 110. It is obvious to one of ordinary skill in the art that the input/output unit may be added, deleted, and/or changed according to the performance and structure of the electronic device 100.

According to one or more embodiments, the display 140 may perform functions for outputting information in the form of numbers, characters, images, and/or graphics. The display 140 may include at least one hardware module for output. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 140 may display a screen corresponding to data received from the processor 110. The display 140 may be referred to as an ‘output unit’, a ‘display unit’, or by other terms having an equivalent technical meaning. “Screen” may include an image displayed on the display of the electronic device. “Image” may be referred to as a frame. Various types of objects, such as icons, text, photos, videos, widgets, etc. may be displayed on the screen.

According to one or more embodiments, the communication unit 150 may provide a wired/wireless communication interface that enables communication with an external device. The communication unit 150 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 110. An AP may include a device for connecting devices by related standards using Wi-Fi in a computer network. The short-range communication unit may perform short-range communication wirelessly with an external device under the control of the processor 110. Short-range communication may include Bluetooth, Bluetooth low energy, infrared data association (IrDA), ultra wideband (UWB), and near-field communication (NFC). The external device may include a server device and a mobile terminal (e.g., phone, tablet, etc.) providing, e.g., a video service.

According to one or more embodiments, the processor 110 may control at least one other component of the electronic device 100 and/or execute computation or data processing regarding communication by executing at least one instruction 121 stored in the memory 120. The processor 110 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

In one or more embodiments, the processor 110 may execute, e.g., software to control at least one other component (e.g., a hardware or software component) of the electronic device 100 connected with the processor 110 and may process or compute various data. According to one or more embodiments, as at least part of the data processing or computation, the processor 110 may store a command or data received from another component onto a volatile memory, process the command or the data stored in the volatile memory, and store resulting data in a non-volatile memory. According to one or more embodiments, the processor 110 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. For example, in a case where the electronic device 100 includes the main processor and the auxiliary processor, the auxiliary processor may be configured to use lower power than the main processor or to be specified for a designated function. The auxiliary processor may be implemented separately from, or as part of, the main processor.

In one or more embodiments, the processor may obtain image frame data from at least one of the memory 120, the image input unit 130, or the communication unit 150. The processor may receive image frame data from at least one of the memory 120, the image input unit 130, or the communication unit 150. The image frame data may include data regarding a frame constituting an image. For example, the image frame data may be identified from the memory 120 (e.g., an image recorded and stored). For example, the image frame data may include data obtained from the communication unit 150 or the image input unit 130 (e.g., real-time streaming image).

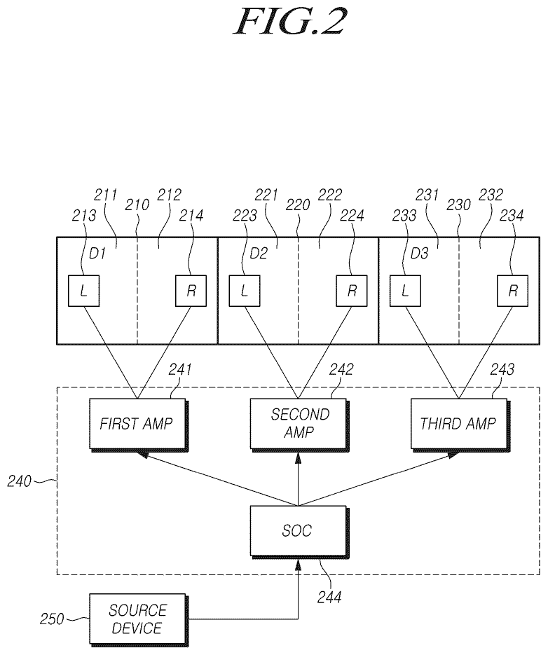

FIG. 2 illustrates an example of a connection structure of the display devices according to one or more embodiments.

Referring to FIG. 2, the connection structure may include a plurality of display devices 210, 220, 230, an external electronic device 240, and a source device 250. Although the drawing illustrates a case where three display devices are connected as an example, this is an illustration and embodiments of the disclosure may be applied even in a case where fewer or more than three display devices are connected. Further, in the following description, the external electronic device 240 is described as being a separate device from the plurality of display devices 210, 220, 230, but this is an illustration and all or some components of the external electronic device 240 may be included in the plurality of display devices 210, 220, 230. In other words, all or some functions of the external electronic device 240 described below may be performed by at least one display device among the plurality of display devices 210, 220, 230.

In one or more embodiments, the display area of the display devices 210, 220, 230 may be divided into a first area 211, 221, 231 and a second area 212, 222, 232. The first area may include a left area based on the center of the display area, and the second area may include a right area based on the center of the display area. In the following description, the area is described as being divided into two areas, a first area and a second area, but it may be classified into more than two areas.

In one or more embodiments, the display devices 210, 220, 230 may include a first speaker 213, 223, 233 and a second speaker 214, 224, 234. The first speaker may include a speaker disposed in a portion corresponding to the first area of each display device. The second speaker may include a speaker disposed in a portion corresponding to the second area of each display device.

In one or more embodiments, the external electronic device 240 may control the image and sound of the plurality of display devices 210, 220, 230. The external electronic device 240 may include amplifiers (e.g., the first amplifier 241, the second amplifier 242, the third amplifier 243) for controlling sound of the plurality of display devices 210, 220, 230. The external electronic device 240 may include an SoC 244 for controlling the amplifiers. The external electronic device 240 may be referred to as an “image transceiving device.”

In one or more embodiments, the SoC 244 may analyze an image signal and a sound signal input from the source device 250. The SoC 244 may analyze an image signal input from the source device 250 to identify a volatility value of a screen to be displayed on the plurality of display devices 210, 220, 230. The volatility value may include a value indicating a degree to which a screen changes. In other words, the volatility value may include a value indicating how quickly pixels or elements on a screen of a display device change over time. The volatility value may indicate a degree of movement or change in a screen. For example, the SoC 244 may identify a volatility value of a screen to be displayed on each display device using motion lighting technology that determines volatility of an image. For example, the SoC 244 may identify a volatility value by identifying the number of pixel variations in frames of an image signal. For example, the SoC 244 may use object recognition technology to identify a volatility value based on position, movement, etc. of objects included in screens displayed on each display device. For example, an electronic device may identify a refresh rate and a frame rate corresponding to a screen of a display device and determine a volatility value based on the refresh rate and the frame rate. The volatility value may be referred to as a “screen change amount indicator” or “screen dynamics indicator.”

In one or more embodiments, the external electronic device 240 may control sound output of the plurality of display dev ices 210, 220, 230 through the amplifiers 241, 242, 243. For example, the external electronic device 240 may transmit a signal for controlling sound output of the display device 210 through the first amplifier 241 connected to the first speaker 213 and the second speaker 214. For example, the external electronic device 240 may transmit a signal for controlling sound output of the display device 220 through the second amplifier 242 connected to the first speaker 223 and the second speaker 224. For example, the external electronic device 240 may transmit a signal for controlling sound output of the display device 230 through the third amplifier 243 connected to the first speaker 233 and the second speaker 234.

Although the drawing illustrates that the SoC 244 is included in the external electronic device 240, in one or more embodiments, the SoC 244 may be included in at least one display device among the plurality of display devices. In other words, the SoC 244 may be included in at least one display device among the plurality of display devices 210, 220, 230 rather than the external electronic device 240. In a case where the SoC 244 is included in at least one display device among the plurality of display devices, the external electronic device 240 and the at least one display device including the SoC 244 may perform operations for controlling image and sound signals of the plurality of display devices 210, 220, 230.

In one or more embodiments, the external electronic device 240 may transmit image and sound signals to the plurality of display devices 210, 220, 230 wirelessly or wiredly. For example, in a case where the external electronic device 240 and the plurality of display devices 210, 220, 230 are connected wiredly (e.g., HDMI), the external electronic device 240 may transmit image and sound signals to the plurality of display devices 210, 220, 230 wiredly. For example, a communication unit for wireless transmission of image and sound signals may be included in the external electronic device 240. The external electronic device 240 may transmit image and sound signals to the plurality of display devices 210, 220, 230 using the communication unit.

In one or more embodiments, the external electronic device 240 may receive an input signal from the source device 250. The source device 250 is an entity that transmits an input source and may include devices such as a set-top box (STB), PC, server, etc.

In one or more embodiments, the source device 250 may transmit an input signal to the external electronic device 240, or in a case where there is no source device 250, may directly transmit an input signal to any one of the plurality of display devices 210, 220, 230. This may be described in detail in the drawings described below.

In one or more embodiments, one display device among the display devices 210, 220, 230 may perform a role of a master device. Display devices except for the master device among the display devices 210, 220, 230 may perform a role of slave devices. The master device may include a display device that receives an input signal for screen display from the external electronic device 240 or the source device 250 and transmits this to other connected display devices. In other words, the master device may include a display device that receives an input signal first.

In one or more embodiments, the master device may be determined as any one device among the plurality of display devices and the external electronic device 240 based on user settings or type of the display device.

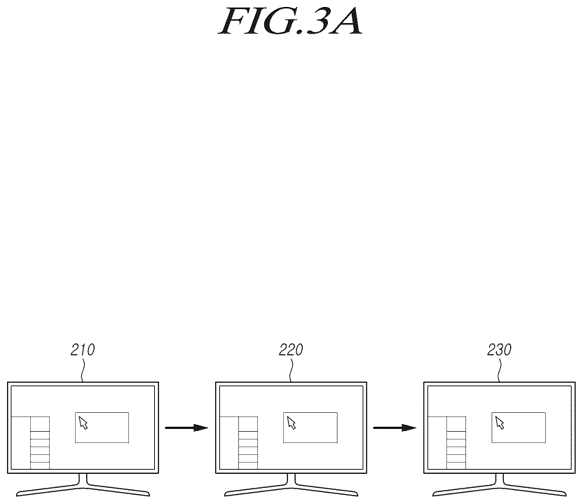

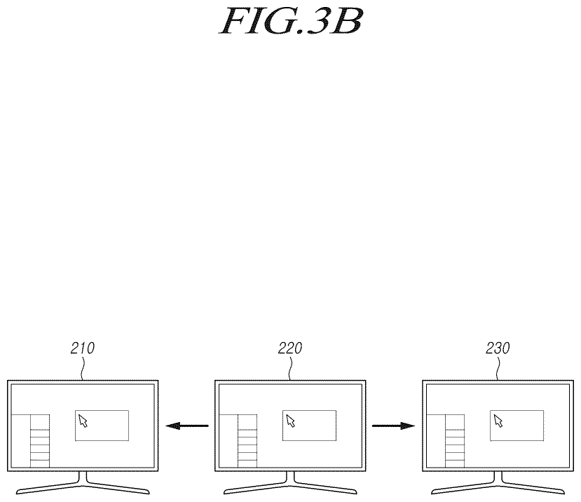

FIG. 3A illustrates an example of a connection structure of the display devices according to one or more embodiments. FIG. 3B illustrates an example of a connection structure of the display devices according to one or more embodiments.

In one or more embodiments, any one device among the plurality of display devices 210, 220, 230 may perform a role of a master device. The master device may perform a role of receiving an input source from a source device or external electronic device and transmitting it to other display devices.

Referring to FIG. 3A, the display device 210 may perform a role of a master device. The display device 210 may receive an input signal from a source device (e.g., source device 250), generate screen and sound control signals to be displayed on the display devices 220, 230 based on this, and then transmit them to the display device 220. The display device 220 may output screen and sound based on control signals received from the display device 210, and may transmit screen and sound control signals to be displayed on the display device 230 to the display device 230. The display device 230 may output screen and sound based on control signals received from the display device 220.

Referring to FIG. 3B, the display device 220 may perform a role of a master device. The display device 220 may receive an input signal from a source device (e.g., source device 250), generate screen and sound control signals to be displayed on the display devices 210, 230 based on this, and then transmit them to the display device 210 and the display device 230 respectively. The display device 210 may output screen and sound based on control signals received from the display device 220. The display device 230 may output screen and sound based on control signals received from the display device 220.

In one or more embodiments, the master device (e.g., the display device 210 in the case of FIG. 3A, the display device 220 in the case of FIG. 3B) may receive an input signal (e.g., image signal and/or sound signal) from a source device (e.g., source device 250) and identify a display mode of the plurality of display devices based on this. The master device may identify information about screens to be displayed on the plurality of display devices including the master device based on the input signal, and identify a display mode of the plurality of display devices including the master device based on this. The display mode may include an extended display mode and a standalone display mode. The extended display mode displays a plurality of display devices based on input from a single source and may include a mode where a screen is displayed in an extended manner. The extended display mode may be referred to as a “multiple monitor mode.” A device in extended display mode may include a device with the extended display function activated. The standalone display mode may include a mode where each of the plurality of display devices displays screens based on different input sources. A device in standalone display mode may include a device with the standalone display function activated.

In one or more embodiments, the master device may compare the number of linked display devices with the number of input sources. For example, in a case where the number of linked display devices equals the number of input sources, it may be determined that all operate in standalone display mode. For example, in a case where the number of linked display devices is greater than the number of input sources, it may be determined that at least two display devices are operating in extended display mode.

In one or more embodiments, the master device may identify that all three devices operate in extended display mode. For example, the master device may identify that the display device 210, the display device 220, and the display device 230 all operate in extended display mode. In this case, the display device 210, the display device 220, and the display device 230 may output screen and sound based on a single input source.

In one or more embodiments, the master device may identify that two display devices operate in extended display mode and the remaining one display device operates in standalone display mode. For example, the master device may identify that the display device 210 and the display device 220 operate in extended display mode, and the display device 230 operates in standalone display mode. In this case, the display device 210 and the display device 220 may output screen and sound based on a single input source, and the display device 230 may be identified as outputting screen and sound through a different type of input source than the display device 210 and the display device 220.

In one or more embodiments, the master device may identify that the display device 210, the display device 220, and the display device 230 each operate in standalone display mode. For example, in a case where input sources input to the display device 210, the display device 220, and the display device 230 are all different, the master device may determine that the display device 210, the display device 220, and the display device 230 all operate in standalone display mode.

In one or more embodiments, the master device (e.g., the display device 210 in the case of FIG. 3A, the display device 220 in the case of FIG. 3B) may receive an input signal (e.g., image signal, sound signal) from a source device (e.g., source device 250), analyze the input signal to identify volatility values of screens displayed on the plurality of display devices (the display device 210, the display device 220, the display device 230).

In one or more embodiments, the master device may compare the identified volatility values of screens of each display device and increase sound intensity of speakers of a display device having the largest volatility value and a display device adjacent to it. For example, the master device may identify the display device having the largest volatility value based on a comparison of the identified volatility values of the screens of the display devices.

In one or more embodiments, in a case where all three display devices 210, 220, 230 are identified as operating in the extended display mode, the master device may analyze the input signal to identify volatility values of screens to be displayed on each display device, and increase sound intensity of a display device displaying a portion with high volatility and speakers adjacent to the display device displaying the portion with high volatility. For example, in a case where it is identified that the display device 220 has the largest volatility value, sound intensity of the first speaker 223, the second speaker 224, and speakers positioned adjacent to the display device 220, which are the second speaker 214 and the first speaker 233, may be increased. For example, in a case where it is identified that the display device 210 has the largest volatility value, the master device may increase the sound intensity of first speaker 213, second speaker 214, and a speaker positioned adjacent to the display device 210, which is the first speaker 223. For example, in a case where it is identified that the display device 230 has the largest volatility value, the master device may increase the sound intensity of first speaker 233, second speaker 234, and a speaker positioned adjacent to the display device 230, which is the second speaker 224. In one or more embodiments, sound of the left channel of the input signal may be output to speakers disposed on the left based on the central point (the first speaker 213, the second speaker 214, the first speaker 223), and sound of the right channel of the input signal may be output to speakers disposed on the right based on the central point (the second speaker 224, the first speaker 233, the second speaker 234). In one or more embodiments, sound intensity of speakers disposed in a display device having the largest volatility value may be increased by a first value, and sound intensity of speakers positioned adjacent to a display device having the largest volatility value may be increased by a second value smaller than the first value.

In one or more embodiments, in a case where two display devices operate in the extended display mode and one display device operates in the standalone display mode, the master device may analyze the input signal of the display devices operating in extended display mode to identify volatility values of screens and increase sound intensity of a display device displaying a portion with high volatility and speakers adjacent to the display device displaying the portion with high volatility. For example, in case of identifying that the display device 210 operates in standalone display mode and the display device 220 and the display device 230 operate in extended display mode, the master device may increase the sound intensity of a display device having a larger volatility value between the display device 220 and the display device 230. For example, in a case where the display device 220 operates in the standalone display mode and the display device 210 and the display device 230 operate in the extended display mode, the master device may increase the sound intensity of the display device having a larger volatility value between the display device 210 and the display device 230. For example, in a case that the display device 230 operates in the standalone display mode and the display device 210 and the display device 220 operate in the extended display mode, the master device may increase the sound intensity of the display device having a larger volatility value between the display device 210 and the display device 220. In one or more embodiments, in a case where a display device operating in the standalone display mode has the largest volatility value, only sound output intensity of the display device operating in standalone display mode may be increased, and sound intensity of the remaining display devices may not be increased.

In one or more embodiments, to identify volatility values of the display devices, the master device may use object (e.g., person, animal, object, etc.) recognition technology utilizing machine learning, etc., to recognize movement of the object and increase the sound of a display device where the object is displayed. In other words, screen display areas of the display devices operating through extended display mode are divided into left areas (e.g., area 1-1, area 2-1) and right areas (e.g., area 1-2, area 2-2) respectively, object recognition technology is used to identify where the object is positioned, and sound intensity of speakers corresponding to the area where the object is positioned may be increased.

In one or more embodiments, the master device may separate the sound source of the identified object and augment only the sound of that object.

In one or more embodiments, the master device may increase only sound intensity of speakers disposed in an area where an object is positioned on a display device where the object is displayed.

In one or more embodiments, in case of identifying that all three display devices operate in standalone display mode, the master device may control sound intensity based on a screen display state of a display device displaying a main screen among the plurality of display devices.

In one or more embodiments, in a case where all of the plurality of display devices operate in standalone display mode, the master device may determine a screen displayed on any one display device among the plurality of display devices as a main screen. For example, in a case where all three display devices operate in standalone display mode, a screen displayed on the display device disposed in the center among the three may be determined as the main screen. For example, in a case where all three display devices operate in standalone display mode, a screen displayed on the display device disposed on the left among the three may be determined as the main screen. For example, in a case where all three display devices operate in standalone display mode, a screen displayed on the display device disposed on the right among the three may be determined as the main screen. For example, a screen having the largest volatility value among screens displayed on the plurality of display devices may be determined as the main screen.

In one or more embodiments, the master device may increase the sound intensity of the main display device or the remaining display devices based on a screen volatility value of a display device displaying the main screen. For example, in case of determining the display device 220 as a display device displaying the main screen, if the screen volatility value of the display device 220 is above a predetermined value, sound intensity of the display device 220 may be increased, and sound intensity of the display devices 210, 230 may be decreased or turned off. In a case where the screen volatility value of the display device 220 is below a predetermined value, the sound intensity of the display device 220 may be decreased, and the sound intensity of the display devices 210, 230 may be decreased or turned off. In other words, in a circumstance in which a main screen (e.g., game execution screen) is displayed on the display device disposed in the center and other content such as additional information and advertisements are displayed on the remaining display devices 210, 230, sound of the main screen and supplementary screens may be controlled according to the progress state of the main screen. During game progress (in a case where the volatility value is above a predetermined value), focus may be on the sound of the main screen and, in a case where the game is stopped (in a case where the volatility value is less than a predetermined value), focus may be on the sound of supplementary screens of the display devices 210, 230 to provide stereophonic sound.

In one or more embodiments, in a case where it is identified that the master device itself has the largest volatility value, the master device may increase the sound intensity of the master device and sound intensity of speakers disposed in portions adjacent to the master device.

In one or more embodiments, in case of identifying that another display device other than the master device has the largest volatility value, the master device may include information instructing to increase the sound intensity of the other display device in control signals transmitted to the other display device.

In one or more embodiments, the master device may control sound output of the display devices in response to identifying that all three display devices operate in standalone display mode and then at least two display devices switch to extended display mode. For example, in a case where all three display devices operate in standalone display mode, while controlling sound of the three display devices based on respective source inputs, in case of identifying that display devices 210, 220 switch to extended display mode, display devices 210, 220 may be controlled to operate according to sound intensity control according to the extended display mode described above. Such content may be described in detail with tables in the drawings described below.

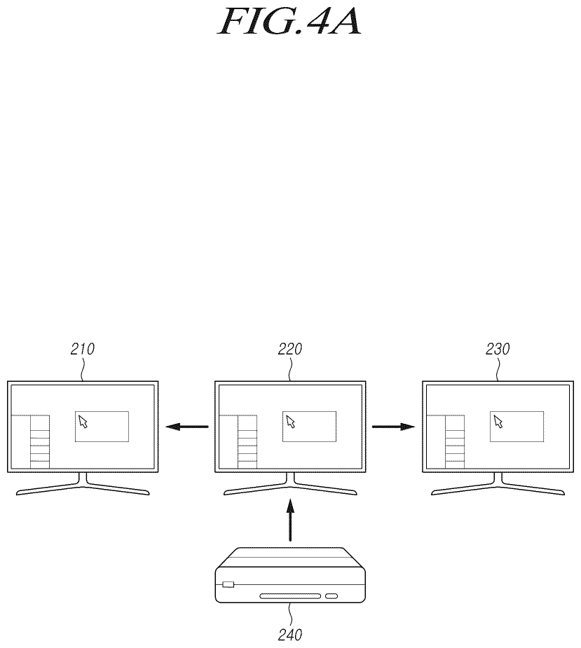

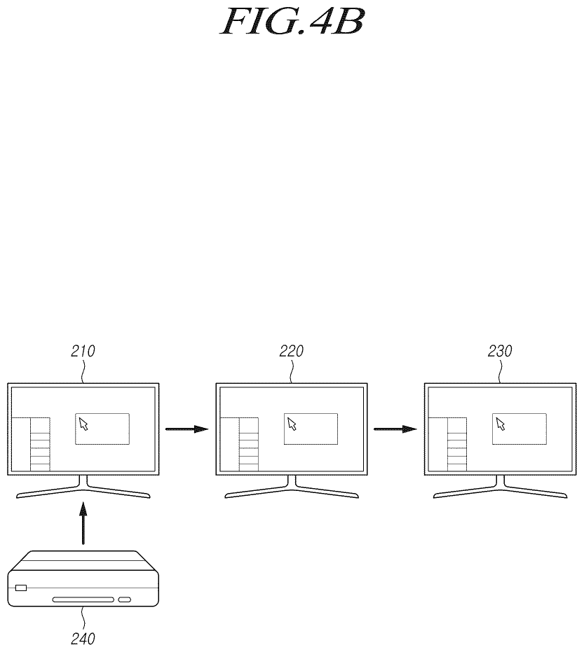

FIG. 4A illustrates an example of a connection structure between an external electronic device and display devices according to one or more embodiments. FIG. 4B illustrates an example of a connection structure between an external electronic device and display devices according to one or more embodiments.

In one or more embodiments, any one device among the plurality of display devices 210, 220, 230 may perform a role of a master device. The master device may perform a role of receiving an input source from a source device or external electronic device 240 and transmitting it to other display devices.

Referring to FIG. 4A, the display device 220 may perform a role of a master device. The display device 220 may receive an input signal from external electronic device 240, generate screen and sound control signals to be displayed on the display devices 210, 230 based on this, and then transmit them to the display device 210 and the display device 230 respectively. The display device 210 may output screen and sound based on control signals received from the display device 220. The display device 230 may output screen and sound based on control signals received from the display device 220.

Referring to FIG. 4B, the display device 210 may perform a role of a master device. The display device 210 may receive an input signal from external electronic device 240, generate screen and sound control signals to be displayed on the display devices 220, 230 based on this, and then transmit them to the display device 220. The display device 220 may output screen and sound based on control signals received from the display device 210, and may transmit screen and sound control signals to be displayed on the display device 230 to the display device 230. The display device 230 may output screen and sound based on control signals received from the display device 220.

In one or more embodiments, the external electronic device 240 or the master device (e.g., the display device 220 in the case of FIG. 4A, the display device 210 in the case of FIG. 4B) may receive an input signal (e.g., image signal and/or sound signal) from external electronic device 240 and identify a display mode of the plurality of display devices based on this. In the following description, the external electronic device 240 identifying the display mode of the plurality of display devices and controlling sound of the display devices accordingly is described as an example, but this is only an illustration, and as in FIGS. 3A and 3B, a master device may also identify the display mode of the plurality of display devices and control sound of the display devices accordingly.

In the following description, the external electronic device 240 is described as being a separate device from the plurality of display devices, but this is an illustration and all or some components of the external electronic device may be included in the plurality of display devices. In other words, all or some functions of the external electronic device 240 described below may be performed by at least one display device among the plurality of display devices 210, 220, 230. The external electronic device may be referred to as an “image transceiving device.” For example, an SoC (e.g., SoC 244) may be included not only in the external electronic device 240 but also in at least one display device among the plurality of display devices. In other words, the SoC may be included in at least one display device among the plurality of display devices 210, 220, 230 rather than external electronic device 240. In a case where the SoC is included in at least one display device among the plurality of display devices, the external electronic device 240 and the at least one display device including the SoC may perform operations for controlling image and sound signals of the plurality of display devices 210, 220, 230.

In one or more embodiments, the external electronic device 240 may identify information about screens to be displayed on the plurality of display devices based on the input signal, and identify a display mode of the plurality of display devices based on this. The display mode may include an extended display mode and a standalone display mode. The extended display mode displays a plurality of display devices based on input from a single source and may include a mode where a screen is displayed in an extended manner. The extended display mode may be referred to as a “multiple monitor mode.” The standalone display mode may include a mode where each of the plurality of display devices displays screens based on different input sources.

In one or more embodiments, the external electronic device 240 may compare the number of linked display devices with the number of input sources. For example, in a case where the number of linked display devices equals the number of input sources, it may be determined that all operate in standalone display mode. For example, in a case where the number of linked display devices is greater than the number of input sources, it may be determined that at least two display devices are operating in extended display mode.

In one or more embodiments, the external electronic device 240 may identify that all three display devices operate in extended display mode. The operation of the external electronic device 240 identifying that three display devices operate in extended display mode may include an operation of identifying that the extended display function is activated. For example, the external electronic device 240 may identify that the display device 210, the display device 220, and the display device 230 all operate in extended display mode. In this case, the display device 210, the display device 220, and the display device 230 may output screen and sound based on a single input source.

In one or more embodiments, the external electronic device 240 may identify that two display devices operate in extended display mode and the remaining one display device operates in standalone display mode. The operation of the external electronic device 240 identifying that two display devices operate in extended display mode may include an operation of identifying that the extended display function of the two display devices is activated. For example, the external electronic device 240 may identify that the display device 210 and the display device 220 operate in extended display mode, and the display device 230 operates in standalone display mode. In this case, the display device 210 and the display device 220 may output screen and sound based on a single input source, and the display device 230 may be identified as outputting screen and sound through a different type of input source than the display device 210 and the display device 220.

In one or more embodiments, the external electronic device 240 may identify that the display device 210, the display device 220, and the display device 230 each operate in standalone display mode. For example, in a case where input sources input to the display device 210, the display device 220, and the display device 230 are all different, the external electronic device 240 may determine that the display device 210, the display device 220, and the display device 230 all operate in standalone display mode.

In one or more embodiments, the external electronic device 240 may receive an input signal (e.g., image signal, sound signal) from a source device (e.g., source device 250), analyze the input signal to identify volatility values of screens displayed on the plurality of display devices (the display device 210, the display device 220, the display device 230).

In one or more embodiments, the external electronic device 240 may compare the identified volatility values of screens of each display device and increase the sound intensity of speakers of a display device having the largest volatility value and a display device adjacent to it.

In one or more embodiments, in case of identifying that all three display devices 210, 220, 230 operate in extended display mode, the external electronic device 240 may analyze the input signal to identify volatility values of screens to be displayed on each display device, and increase the sound intensity of a display device displaying a portion with high volatility and speakers adjacent to the display device displaying the portion with high volatility. For example, in a case where it is identified that the display device 220 has the largest volatility value, sound intensity of the first speaker 223, the second speaker 224, and speakers positioned adjacent to the display device 220, which are the second speaker 214 and the first speaker 233, may be increased. For example, in a case where it is identified that the display device 210 has the largest volatility value, the external electronic device 240 may increase the sound intensity of the first speaker 213, the second speaker 214, and a speaker positioned adjacent to the display device 210, which is the first speaker 223. For example, in a case where it is identified that the display device 230 has the largest volatility value, the external electronic device 240 may increase the sound intensity of the first speaker 233, the second speaker 234, and a speaker positioned adjacent to the display device 230, which is the second speaker 224. In one or more embodiments, sound of the left channel of the input signal may be output to speakers disposed on the left based on the central point (the first speaker 213, the second speaker 214, the first speaker 223), and sound of the right channel of the input signal may be output to speakers disposed on the right based on the central point (the second speaker 224, the first speaker 233, the second speaker 234). In one or more embodiments, sound intensity of speakers disposed in a display device having the largest volatility value may be increased by a first value, and sound intensity of speakers positioned adjacent to a display device having the largest volatility value may be increased by a second value smaller than the first value.

In one or more embodiments, in case of identifying that two display devices operate in extended display mode and one display device operates in standalone display mode, the external electronic device 240 may analyze the input signal of the display devices operating in extended display mode to identify volatility values of screens and increase the sound intensity of a display device displaying a portion with high volatility and speakers adjacent to the display device displaying the portion with high volatility. For example, in case of identifying that the display device 210 operates in standalone display mode and the display device 220 and the display device 230 operate in extended display mode, the external electronic device 240 may increase the sound intensity of a display device having a larger volatility value between the display device 220 and the display device 230. For example, in case of identifying that the display device 210 operates in standalone display mode and the display device 220 and the display device 230 operate in extended display mode, the external electronic device 240 may increase the sound intensity of a display device having a larger volatility value between the display device 220 and the display device 230. For example, in case of identifying that the display device 220 operates in standalone display mode and the display device 210 and the display device 230 operate in extended display mode, the external electronic device 240 may increase the sound intensity of a display device having a larger volatility value between the display device 210 and the display device 230. For example, in case of identifying that the display device 230 operates in standalone display mode and the display device 210 and the display device 220 operate in extended display mode, the external electronic device 240 may increase the sound intensity of a display device having a larger volatility value between the display device 210 and the display device 220. In one or more embodiments, in a case where a display device operating in standalone display mode has the largest volatility value, only sound output intensity of the display device operating in standalone display mode may be increased, and sound intensity of the remaining display devices may not be increased.

In one or more embodiments, to identify volatility values of the display devices, the external electronic device 240 may use object (e.g., person, animal, object, etc.) recognition technology utilizing machine learning, etc., to recognize movement of the object and increase the sound of a display device where the object is displayed. In other words, screen display areas of the display devices operating through extended display mode are divided into left areas (e.g., area 1-1, area 2-1) and right areas (e.g., area 1-2, area 2-2) respectively, object recognition technology is used to identify where the object is positioned, and sound intensity of speakers corresponding to the area where the object is positioned may be increased.

In one or more embodiments, the external electronic device 240 may separate the sound source of the identified object and augment only the sound of that object.

In one or more embodiments, the external electronic device 240 may increase only sound intensity of speakers disposed in an area where an object is positioned on a display device where the object is displayed.

In one or more embodiments, in case of identifying that all three display devices operate in standalone display mode, the external electronic device 240 may control sound intensity based on a screen display state of a display device displaying a main screen among the plurality of display devices.

In one or more embodiments, in a case where all of the plurality of display devices operate in standalone display mode, the external electronic device 240 may determine a screen displayed on any one display device among the plurality of display devices as a main screen. For example, in a case where all three display devices operate in standalone display mode, a screen displayed on the display device disposed in the center among the three may be determined as the main screen. For example, in a case where all three display devices operate in standalone display mode, a screen displayed on the display device disposed on the left among the three may be determined as the main screen. For example, in a case where all three display devices operate in standalone display mode, a screen displayed on the display device disposed on the right among the three may be determined as the main screen. For example, a screen having the largest volatility value among screens displayed on the plurality of display devices may be determined as the main screen.

In one or more embodiments, the external electronic device 240 may increase the sound intensity of the main display device or the remaining display devices based on a screen volatility value of a display device displaying the main screen. For example, in case of determining the display device 220 as a display device displaying the main screen, if the screen volatility value of the display device 220 is above a predetermined value, sound intensity of the display device 220 may be increased, and sound intensity of the display devices 210, 230 may be decreased or turned off. In a case where the screen volatility value of the display device 220 is below a predetermined value, the sound intensity of the display device 220 may be decreased, and the sound intensity of the display devices 210, 230 may be decreased or turned off. In other words, in a circumstance in which a main screen (e.g., game execution screen) is displayed on the display device disposed in the center and other content such as additional information and advertisements are displayed on the remaining display devices 210, 230, sound of the main screen and supplementary screens may be controlled according to the progress state of the main screen. During game progress (in a case where the volatility value is above a predetermined value), focus is on sound of the main screen and, in a case where the game is stopped (in a case where the volatility value is less than a predetermined value), focus is on sound of supplementary screens of display devices 210, 220 to provide stereophonic sound.

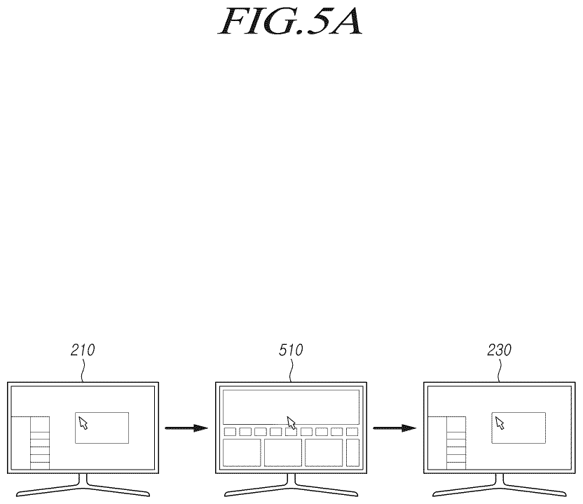

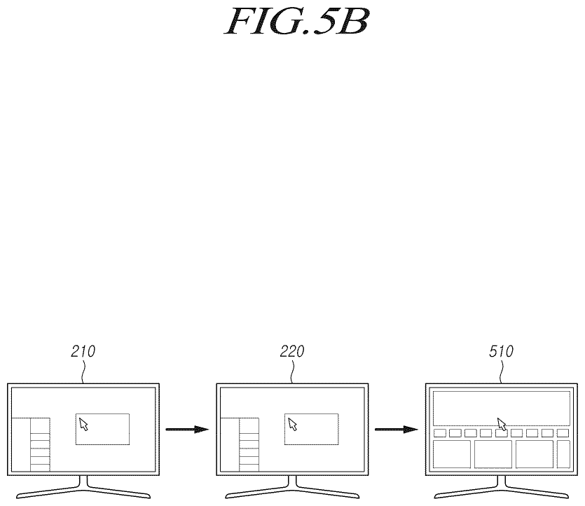

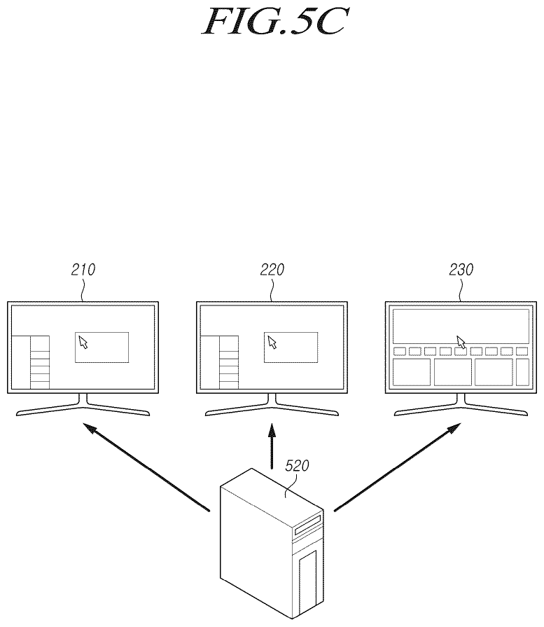

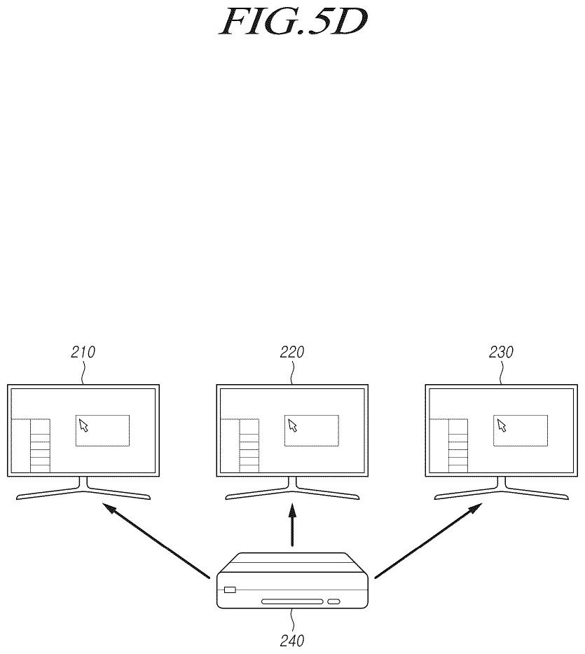

FIG. 5A illustrates an example of a connection structure of the display devices according to one or more embodiments. FIG. 5B illustrates an example of a connection structure of the display devices according to one or more embodiments. FIG. 5C illustrates an example of a connection structure between a display device and a server according to one or more embodiments. FIG. 5D illustrates an example of a connection structure between a display device and an external electronic device according to one or more embodiments. In one or more embodiments, a display device 510 may include a display device of a different type from display devices 210, 220, 230.

In one or more embodiments, the display device 510 may have information different from sound setting information, screen setting information, etc. that the display devices 210, 220, 230 may support.

Referring to FIG. 5A, the display device 210 may perform a role of a master device. The display device 210 may receive an input signal from a source device (e.g., source device 250), generate screen and sound control signals to be displayed on the display devices 510, 230 based on the input signal, and then transmit them to the display device 510. The display device 510 may output a screen and sound based on control signals received from the display device 210, and may transmit screen and sound control signals to be displayed on the display device 230 to the display device 230. The display device 230 may output screen and sound based on control signals received from the display device 510.

Referring to FIG. 5B, the display device 210 may perform a role of a master device. The display device 210 may receive an input signal from a source device (e.g., source device 250), generate screen and sound control signals to be displayed on the display devices 220, 510 based on the input signal, and then transmit them to the display device 220. The display device 220 may output screen and sound based on control signals received from the display device 210, and may transmit screen and sound control signals to be displayed on the display device 510 to the display device 510. The display device 510 may output screen and sound based on control signals received from the display device 220.

Even in the connection structures as illustrated in FIGS. 5A and 5B, a master device or external electronic device may identify screen volatility values of the plurality of display devices and control sound intensity. In other words, operations of the master device and external electronic device described in the descriptions of FIGS. 3A, 3B, 4A, and 4B may be equally applied to connections between heterogeneous display devices. However, since device capabilities of the display devices 210, 220, 230 and display device 510 may differ, before performing operations of the master device and external electronic device described in the descriptions of FIGS. 3A, 3B, 4A, and 4B, the master device and external electronic device may identify device capability information of the display device 510.

Referring to FIG. 5C, a connection structure of the display devices according to one or more embodiments may include a connection structure between a server device 520 and a plurality of display devices 210, 220, 230. The server device 520 may be a device that includes all functions of a source device 250 and an external electronic device 240.

In one or more embodiments, in a case where all of the plurality of display devices 210, 220, 230 operate in extended display mode, the plurality of display devices 210, 220, 230 may each receive an input signal from server device 520.

In one or more embodiments, the plurality of display devices 210, 220, 230 may exchange information about their respective sound output settings. In other words, sound levels of each display may be set through information exchange between each display device. A master device, which is any one device among the plurality of display devices 210, 220, 230, or the server device 520 may generate the sound level setting information.

In one or more embodiments, in a case where all of the plurality of display devices 210, 220, 230 operate in standalone display mode, the plurality of display devices 210, 220, 230 may each receive an input signal from server device 520, and sound levels may be adjusted based on screen volatility values of the display devices displaying main screens. This may be controlled by the server device 520 or a master device which is any one device among the plurality of display devices 210, 220, 230. In other words, whether to output sound of the main screen and supplementary screens may be determined according to the display state of the main screen.

In one or more embodiments, the server device 520 or a master device may control sound output based on the degree of current change of a display device. Since the change value of current used in a panel of a display device displaying a screen with a large volatility value is larger, the server device 520 or a master device may increase the sound intensity of a display device with a large current change value.

In one or more embodiments, in signals transmitted from SoCs or scalers of the plurality of display devices to panels, by comparing the degree of change in H pixels and V pixels, the sound intensity of the display device that changes the most may be increased.

Referring to FIG. 5D, the display devices 210, 220, 230 according to one or more embodiments may each be connected to external electronic device 240. The external electronic device 240 may identify operating modes of the plurality of display devices 210, 220, 230. The external electronic device 240 may control sound output of the plurality of display devices 210, 220, 230 based on the identified display mode.

In one or more embodiments, the display devices 210, 220, 230 may each receive an input signal from the external electronic device 240. The input signal may include a signal about image and a signal about sound. The external electronic device 240 may analyze input signals input to the plurality of display devices 210, 220, 230 to identify volatility values of screens displayed on each display device. The external electronic device 240 may increase the sound intensity of a display device having the largest volatility value and may increase the sound intensity of speakers disposed adjacent to the display device having the largest volatility value. The sound of the display devices may also be controlled according to current usage and number of pixel variations through information exchange between display devices.

In one or more embodiments, the external electronic device 240 may receive an input signal from a source device (e.g., the source device 250) and transmit it to the plurality of display devices. The external electronic device 240 may display a main screen on the display device 220 disposed in the center and display other content such as additional information and advertisements on the remaining display devices 210, 230. In this case, the external electronic device 240 may analyze input signals input to the plurality of display devices 210, 220, 230, identify the state of the display device 220 displaying the main screen, and control sound output of the main screen and supplementary screens according to the state. In this case, the external electronic device 240 may control information exchange between display devices, or sound output may be controlled through mutual information transmission between display devices.

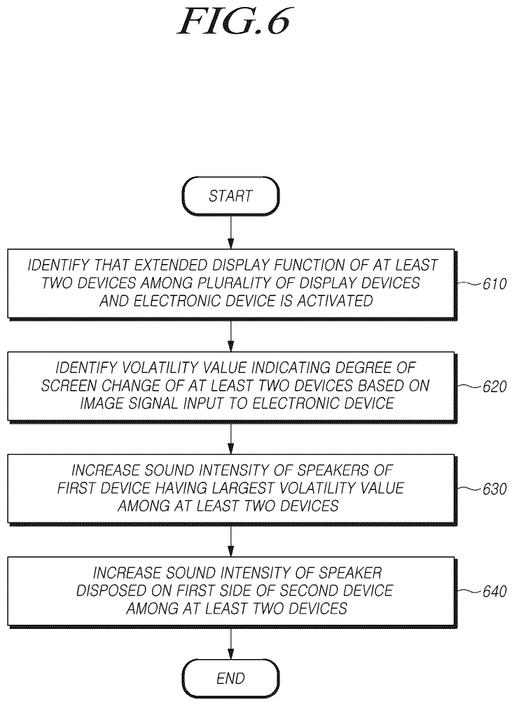

FIG. 6 illustrates an operation flow of an electronic device according to one or more embodiments. The electronic device of FIG. 6 may be a device corresponding to electronic device 100 of FIG. 1, the display devices 210, 220, 230 or the external electronic device 240 of FIG. 2, the master device of FIGS. 3A and 3B, or the external electronic device 240 of FIGS. 4A and 4B. In other words, the electronic device may be an operation of a master device (i.e., any one display device among the plurality of display devices) or an external electronic device that performs operations for controlling screen output and sound of the plurality of display devices. In the description of FIG. 6, descriptions overlapping content described in previous drawings may be omitted. The description of FIG. 6 describes a structure in which three display devices are connected as an example, but this is only an illustration and embodiments of the disclosure may be similarly applied even in a case where more or fewer than three display devices are present.

According to one or more embodiments, in operation 610, an electronic device may identify that an extended display function of at least two devices among a plurality of display devices and the electronic device is activated.

In one or more embodiments, the electronic device may be any one display device among the plurality of display devices. In this case, the electronic device may perform a role of a master device. In this case, the electronic device may also be included in the at least two devices.

In one or more embodiments, the electronic device may be an electronic device (e.g., the external electronic device 240) that transmits input signals input from a source device to the plurality of display devices, not the plurality of display devices. In this case, the electronic device may transmit an input signal and control signals for controlling screen and sound of the plurality of display devices to a display device performing a master role among the plurality of display devices. In this case, the electronic device may not be included in the at least two devices.

In one or more embodiments, the extended display function may include a function for controlling two or more display devices based on a single input source. For example, it may include a function that divides and displays one image or picture on two or more display devices.

In one or more embodiments, the electronic device may identify that the extended display function of two devices is activated. In this case, the two devices may display one screen as a whole based on one input, and the remaining one device may display one screen based on an input different from the input of the two devices. The electronic device may identify information about screens displayed on the two devices and the remaining one device, and control screen display and sound settings of the two devices and the remaining one device based on this.

In one or more embodiments, the electronic device may identify that the extended display function of three display devices is activated. In this case, the three devices may display one screen as a whole based on one input. The electronic device may identify information about screens displayed on the three devices and control screen display and sound settings of the three devices based on this.

In one or more embodiments, the electronic device may identify that the extended display function of the at least two devices is activated in response to identifying that the at least two devices are physically coupled (e.g., a hinge, high-definition multimedia interface (HDMI), USB-C). If the at least two devices are already connected through an HDMI connector, in case of identifying a case where the at least two devices are physically connected to abut through not only HDMI but also a hinge, the electronic device may identify that the extended display function of the at least two devices is activated. The meaning of the extended display function being activated may have the same meaning as operating in extended display mode.

In one or more embodiments, in a case where a user input for activating the extended display function is identified in at least one device among the at least two devices, the electronic device may determine that the extended display function of the at least two devices is activated.

According to one or more embodiments, in operation 620, the electronic device may identify a volatility value indicating a degree of screen change of the at least two devices based on an image signal input to the electronic device.

In one or more embodiments, the electronic device may identify information about screens displayed on the plurality of display devices from the input signal. The electronic device may identify a volatility value of a screen displayed on each display device based on the input signal.

In one or more embodiments, the electronic device may identify the volatility value of the at least two devices based on a degree of change of pixels displayed on screens of the at least two devices. For example, volatility values of each device may be identified by identifying the degree of change of H pixels and V pixels.

In one or more embodiments, the electronic device may perform object recognition using artificial intelligence technology, etc., to identify position of objects, degree of object movement, etc., and identify volatility values of the display devices based on this.

According to one or more embodiments, in operation 630, the electronic device may increase the sound intensity of speakers of a first device having a largest volatility value among the at least two devices. By increasing sound intensity of a device having the largest volatility value, stereophonic sound service may be provided.

In one or more embodiments, the first device may include at least two speakers (e.g., first speaker, the second speaker).

According to one or more embodiments, in operation 640, the electronic device may increase the sound intensity of a speaker disposed on a first side surface of a second device among the at least two devices.

In one or more embodiments, in a case where the number of at least two devices is three, the second device may be the remaining two devices except for the first device.

In one or more embodiments, in a case where the number of at least two devices is two, the second device may be the remaining one device except for the first device.

In one or more embodiments, the first side surface of the second device may include a surface close to the first device. For example, in a case where the first device is the display device 210 and the second device is the display device 220, the first side surface of the second device may be a surface where the first speaker of the second device is positioned.

In one or more embodiments, the electronic device may increase the sound intensity of at least two speakers of the first device by a first value and increase the sound intensity of a speaker disposed on the first side surface of the second device by a second value. The first value may have a value greater than the second value.

In one or more embodiments, a sound channel of speakers positioned in a first direction from a central point among speakers of the at least two devices is a first channel, and a sound channel of speakers positioned in a second direction opposite to the first direction from the central point among speakers of the at least two devices may be a second channel. The central point may be a central point of the at least two devices.

In one or more embodiments, the volatility value of the second device may have a value greater than a predetermined value. In other words, even in a case where it is a device operating through extended display mode with the first device, in a case where the degree of screen change is below a predetermined level, the sound intensity of the second device may not be increased.

In one or more embodiments, to identify a volatility value indicating a degree of screen change of the at least two devices based on an image signal input to the electronic device, the electronic device may identify frames of a screen displayed on the at least two devices and may measure a difference in pixel values of the frames. The greater the difference in pixel values, the greater the volatility value may be determined to be.

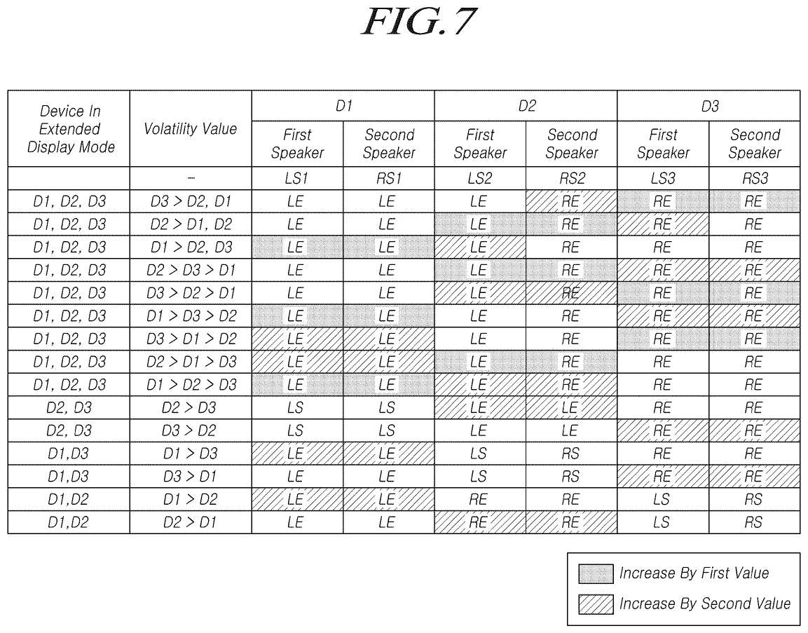

FIG. 7 illustrates an example of sound control of a display device according to one or more embodiments. FIG. 7 illustrates cases of controlling sound output of three display devices according to the operation flow of the electronic device according to FIG. 6. For example, it illustrates an example of controlling sound output based on volatility values of the display devices.

Referring to FIG. 7, D1 may indicate a display device corresponding to the display device 210, D2 may indicate a display device corresponding to the display device 220, and D3 may indicate a display device corresponding to the display device 230.

In one or more embodiments, “device in extended display mode” may include at least two devices in the description of FIG. 6.

In one or more embodiments, the volatility value in FIG. 7 may be a value indicating a degree of screen change of each display device.

Referring to FIG. 7, a case where three display devices are connected is described as an example, but this is only an illustration and embodiments of the disclosure may be applied even in a case where more or fewer than three display devices are connected.

In one or more embodiments, a first speaker may include a speaker disposed on a first side (e.g., left) of a display device, and a second speaker may include a speaker disposed on a second side (e.g., right) of the display device. In the following description, the display device is described as including only a first speaker and a second speaker as an example, but embodiments of the disclosure may be equally applied even in a case where the display device includes more than two speakers or is connected to more than two sound output devices.

In one or more embodiments, the sound of the left channel of a stereo system may be output through the first speaker, and sound of the right channel of the stereo system may be output through the second speaker.

In one or more embodiments, LS (left channel of single display) may indicate sound of the left channel of a sound signal input to a display device operating as a standalone display.

In one or more embodiments, RS (right channel of single display) may indicate sound of the right channel of a sound signal input to a display device operating as a standalone display.

In one or more embodiments, LE (left channel of extended display) may indicate sound of the left channel of a sound signal input to display devices with the extended display function activated.

In one or more embodiments, RE (right channel of extended display) may indicate sound of the right channel of a sound signal input to display devices with the extended display function activated.

In one or more embodiments, D1, D2, D3 may be disposed from left to right in order.

According to one or more embodiments, in at least two devices with the extended display function activated, the sound of the left channel (LE) may be output based on the central point of the at least two devices, and sound of the right channel (RE) may be output from speakers disposed on the right based on the central point.

In one or more embodiments, in a case where D1, D2, D3 all operate in extended display mode, the central point of at least two devices may be the central point of D2. Therefore, in a case where D1, D2, D3 all operate in extended display mode, LE may be output from the first speaker of D1, the second speaker of D1, and the first speaker of D2 positioned on the left from the central point of D2, and RE may be output from the second speaker of D2, the first speaker of D3, and the second speaker of D3 positioned on the right from the central point of D2.

In one or more embodiments, in a case where two devices among D1, D2, D3 operate in extended display mode, LE may be output from speakers disposed on the left based on the central point of the two devices, RE may be output from speakers disposed on the right, and LS may be output from the first speaker and RS may be output from the second speaker of the remaining one device, i.e., the device operating in standalone display mode. For example, in a case where the two devices operating in extended display mode are D2, D3, since the surface where D2, D3 abut is the central point, LE may be output from the first speaker and second speaker of D2, which are speakers disposed on the left based on the abutting surface, and RE may be output from the first speaker and second speaker of D3, which are speakers disposed on the right. Further, LS may be output from the first speaker of D1 operating standalone, and RS may be output from the second speaker.

In one or more embodiments, in a case where three devices all operate in extended display mode, the sound intensity of a device having the largest volatility value may be increased by a first value, and the sound intensity of speakers disposed on a surface close to the device having the largest volatility value may be increased by a second value. For example, in a case where D1, D2, D3 all operate in extended display mode and the volatility value of D2 is largest, the sound intensity of the first speaker and second speaker of D2 may be increased by a first value, and the sound intensity of the second speaker of D1 and the first speaker of D3 disposed on a surface close to D2 may be increased by a second value.

In one or more embodiments, in a case where two devices operate in extended display mode, only sound intensity of the display devices operating in extended display mode may be increased. For example, in a case where D2, D3 operate in extended display mode and D1 operates in standalone display mode, in a case where the volatility value of D2 is greater than the volatility value of D3, only sound intensity of speakers of D2 may be increased by a second value.

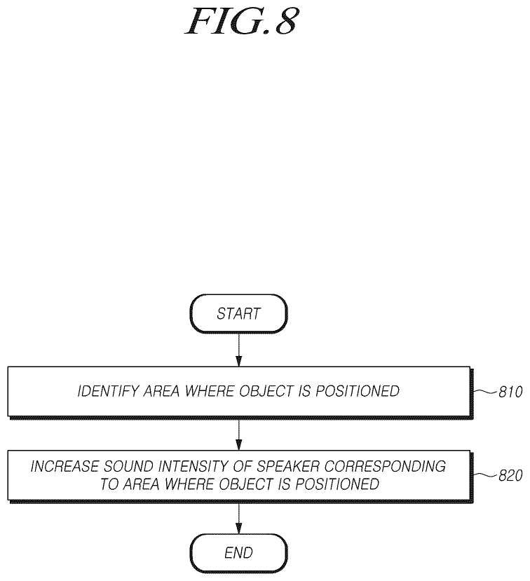

FIG. 8 illustrates an operation flow of an electronic device according to one or more embodiments. FIG. 8 may include all operation content of the electronic device of FIG. 6. The operation of the electronic device of FIG. 8 relates to a specific example of an operation in which the electronic device identifies volatility values of a plurality of display devices and increases sound intensity of a display device having the largest volatility value.

In one or more embodiments, the electronic device may identify an area where an object displayed on screens of the display devices is positioned based on an input signal. The area where an object is positioned may include an area where an object (e.g., person, animal, object, etc.) displayed through an image is positioned. The area where an object is positioned may be divided into a left area and a right area for each display device. In the following description, the area where an object is positioned is described as being divided into two areas, a left area and a right area, as an example, but this is an illustration and it may be divided into more than two areas.

According to one or more embodiments, in operation 820, the electronic device may increase the sound intensity of a speaker corresponding to the area where the object is positioned.

In one or more embodiments, in a case where it is identified that an object is positioned in the left area of a display device, the sound intensity of a first speaker disposed in the left area of the display device may be increased. In case of identification that an object is positioned in the right area of a display device, the sound intensity of a second speaker disposed in the right area of the display device may be increased.

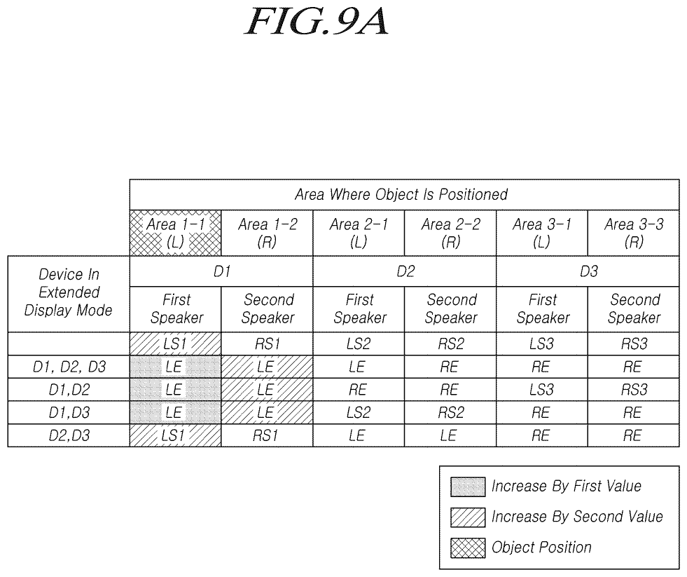

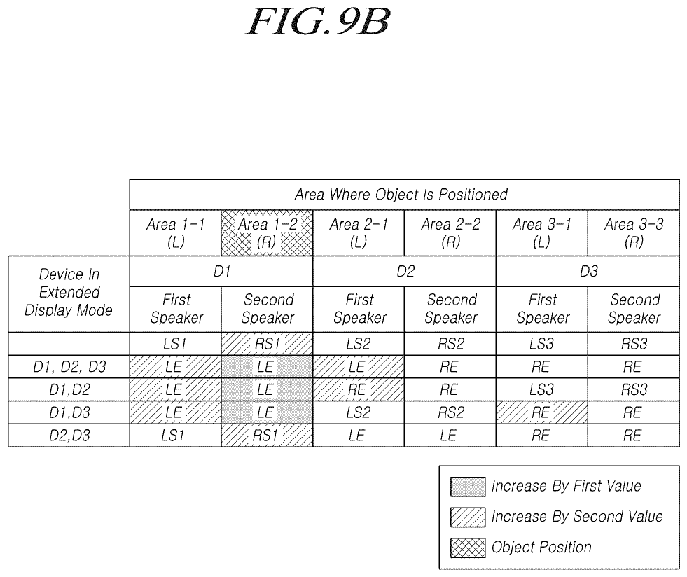

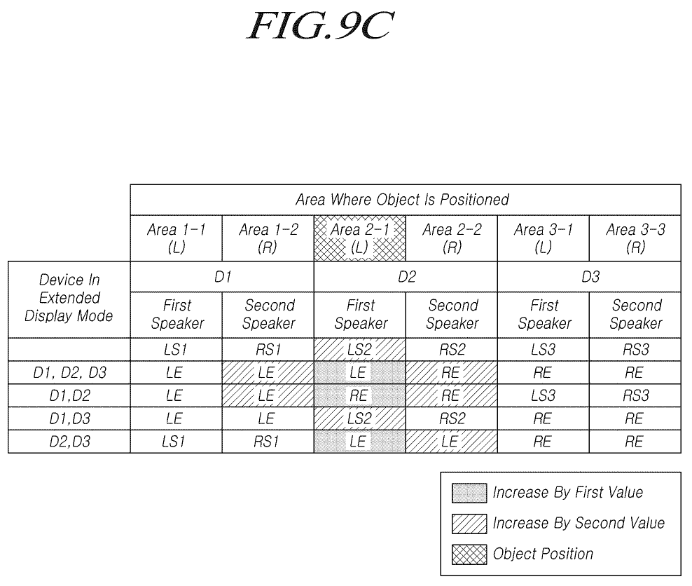

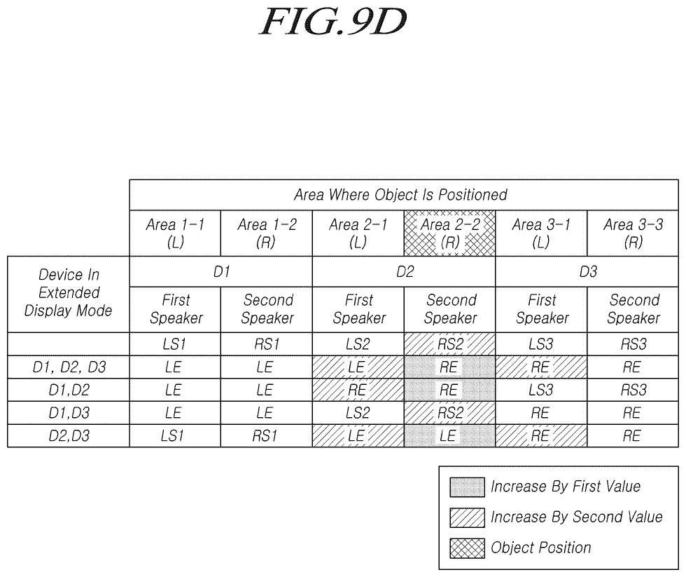

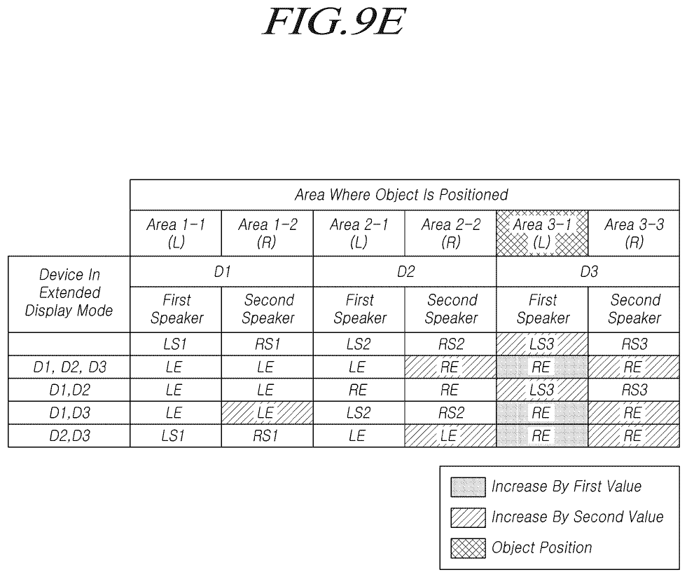

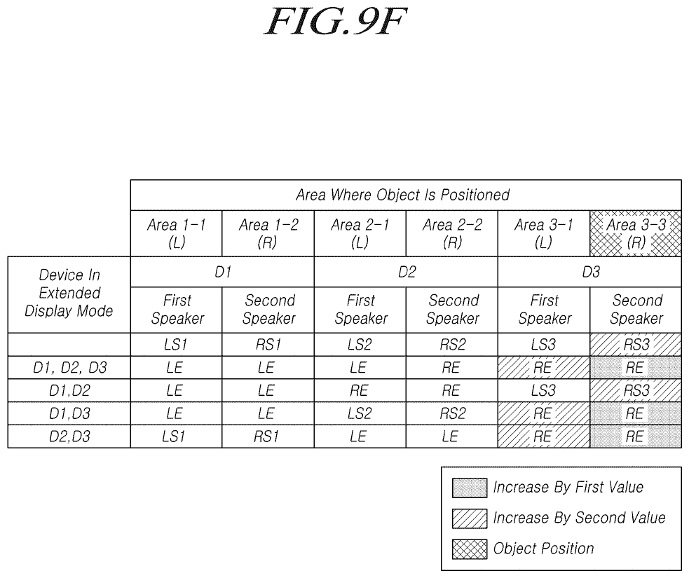

FIG. 9A illustrates an example of sound output control according to an area where an object of an electronic device is positioned according to one or more embodiments. FIG. 9B illustrates an example of sound output control according to an area where an object of an electronic device is positioned according to one or more embodiments. FIG. 9C illustrates an example of sound output control according to an area where an object of an electronic device is positioned according to one or more embodiments. FIG. 9D illustrates an example of sound output control according to an area where an object of an electronic device is positioned according to one or more embodiments. FIG. 9E illustrates an example of sound output control according to an area where an object of an electronic device is positioned according to one or more embodiments. FIG. 9F illustrates an example of sound output control according to an area where an object of an electronic device is positioned according to one or more embodiments. In the description of FIGS. 9A to 9F, descriptions overlapping content described in connection with FIGS. 6 to 8 may be omitted.

In one or more embodiments, a first speaker may include a speaker disposed on a first side (e.g., left) of a display device, and a second speaker may include a speaker disposed on a second side (e.g., right) of the display device. In the following description, the display device is described as including only a first speaker and a second speaker as an example, but embodiments of the disclosure may be equally applied even in a case where the display device includes more than two speakers or is connected to more than two sound output devices.

In one or more embodiments, the sound of the left channel of a stereo system may be output through the first speaker, and sound of the right channel of the stereo system may be output through the second speaker.

In one or more embodiments, LS (left channel of single display) may indicate sound of the left channel of a sound signal input to a display device operating as a standalone display.

In one or more embodiments, RS (right channel of single display) may indicate sound of the right channel of a sound signal input to a display device operating as a standalone display.

In one or more embodiments, LE (left channel of extended display) may indicate sound of the left channel of a sound signal input to display devices with the extended display function activated.

In one or more embodiments, RE (right channel of extended display) may indicate sound of the right channel of a sound signal input to display devices with the extended display function activated.

In one or more embodiments, D1, D2, D3 may be disposed from left to right in order.

According to one or more embodiments, in at least two devices with the extended display function activated, the sound of the left channel (LE) may be output based on the central point of the at least two devices, and sound of the right channel (RE) may be output from speakers disposed on the right based on the central point.

In one or more embodiments, area 1-1 may include the left area of D1. Area 1-2 may include the right area of D2. Area 2-1 may include the left area of D2. Area 2-2 may include the right area of D2. Area 3-1 may include the left area of D3. Area 3-2 may include the right area of D3.

In one or more embodiments, the electronic device may identify the area where an object is positioned as area 1-1, area 1-2, area 2-1, area 2-2, area 3-1, or area 3-2 according to operation 810.

Referring to FIG. 9A, an example of sound control of a plurality of display devices of an electronic device in a case where the area where an object is positioned is area 1-1 is illustrated.

In one or more embodiments, in a case where there is no device in extended display mode, the electronic device may increase the sound intensity of the first speaker of D1 by a second value.

In one or more embodiments, in a case where all three display devices operate in extended display mode, the electronic device may increase the sound intensity of the first speaker of D1 by a first value and increase the sound intensity of the second speaker of D1 adjacent to the first speaker of D1 by a second value.

In one or more embodiments, in a case where two display devices operate in extended display mode (e.g., D1, D2) and the remaining one display device operates in standalone display mode (e.g., D3), the electronic device may increase the sound intensity of the first speaker of D1 by a first value and increase intensity of the second speaker of D1 by a second value.

Referring to FIG. 9B, an example of sound control of a plurality of display devices of an electronic device in a case where the area where an object is positioned is area 1-2 is illustrated.

In one or more embodiments, in a case where there is no device in extended display mode, the electronic device may increase the sound intensity of the second speaker of D1 by a second value.

In one or more embodiments, in a case where all three display devices operate in extended display mode, the electronic device may increase the sound intensity of the second speaker of D1 by a first value and increase the sound intensity of the first speaker of D1 and the first speaker of D2 adjacent to the second speaker of D1 by a second value.

In one or more embodiments, in a case where two display devices operate in extended display mode (e.g., D1, D2) and the remaining one display device operates in standalone display mode (e.g., D3), the electronic device may increase the sound intensity of the second speaker of D1 by a first value, increase intensity of the first speaker of D1 by a second value, and increase the sound intensity of the first speaker of D2 by a second value.

Referring to FIG. 9C, an example of sound control of a plurality of display devices of an electronic device in a case where the area where an object is positioned is area 2-1 is illustrated.

In one or more embodiments, in a case where there is no device in extended display mode, the electronic device may increase the sound intensity of the first speaker of D2 by a second value.

In one or more embodiments, in a case where all three display devices operate in extended display mode, the electronic device may increase the sound intensity of the first speaker of D2 by a first value and increase the sound intensity of the second speaker of D1 and the second speaker of D2 adjacent to the first speaker of D2 by a second value.

In one or more embodiments, in a case where two display devices operate in extended display mode (e.g., D1, D2) and the remaining one display device operates in standalone display mode (e.g., D3), the electronic device may increase the sound intensity of the first speaker of D2 by a first value, increase intensity of the second speaker of D1 by a second value, and increase the sound intensity of the second speaker of D2 by a second value.

Referring to FIG. 9D, an example of sound control of a plurality of display devices of an electronic device in a case where the area where an object is positioned is area 2-2 is illustrated.

In one or more embodiments, in a case where there is no device in extended display mode, the electronic device may increase the sound intensity of the second speaker of D2 by a second value.

In one or more embodiments, in a case where all three display devices operate in extended display mode, the electronic device may increase the sound intensity of the second speaker of D2 by a first value and increase the sound intensity of the first speaker of D2 and the first speaker of D3 adjacent to the second speaker of D2 by a second value.

In one or more embodiments, in a case where two display devices operate in extended display mode (e.g., D1, D2) and the remaining one display device operates in standalone display mode (e.g., D3), the electronic device may increase the sound intensity of the second speaker of D2 by a first value and increase intensity of the first speaker of D2 by a second value.

Referring to FIG. 9E, an example of sound control of a plurality of display devices of an electronic device in a case where the area where an object is positioned is area 3-1 is illustrated.

In one or more embodiments, in a case where there is no device in extended display mode, the electronic device may increase the sound intensity of the first speaker of D3 by a second value.

In one or more embodiments, in a case where all three display devices operate in extended display mode, the electronic device may increase the sound intensity of the first speaker of D3 by a first value and increase the sound intensity of the second speaker of D2 and the second speaker of D3 adjacent to the first speaker of D3 by a second value.

In one or more embodiments, in a case where two display devices operate in extended display mode (e.g., D2, D3) and the remaining one display device operates in standalone display mode (e.g., D1), the electronic device may increase the sound intensity of the first speaker of D3 by a first value, increase intensity of the second speaker of D2 by a second value, and increase the sound intensity of the second speaker of D3 by a second value.

Referring to FIG. 9F, an example of sound control of a plurality of display devices of an electronic device in a case where the area where an object is positioned is area 3-2 is illustrated.

In one or more embodiments, in a case where there is no device in extended display mode, the electronic device may increase the sound intensity of the second speaker of D3 by a second value.

In one or more embodiments, in a case where all three display devices operate in extended display mode, the electronic device may increase the sound intensity of the second speaker of D3 by a first value and increase the sound intensity of the first speaker of D3 adjacent to the second speaker of D3 by a second value.

In one or more embodiments, in a case where two display devices operate in extended display mode (e.g., D1, D2) and the remaining one display device operates in standalone display mode (e.g., D3), the electronic device may increase the sound intensity of the second speaker of D3 by a first value and increase intensity of the first speaker of D3 by a second value.

A method of operating an electronic device connected to a plurality of display devices according to one or more embodiments of the disclosure may include an operation for identifying that an extended display function of at least two devices among the plurality of display devices and the electronic device is activated. In one or more embodiments, the method of operating an electronic device may include an operation for increasing sound intensity of speakers of a first device having a largest volatility value among the at least two devices. In one or more embodiments, the method of operating an electronic device may include an operation for increasing sound intensity of a speaker disposed adjacent to the first device. In one or more embodiments, the volatility value may indicate a degree of screen change of the at least two devices. In one or more embodiments, the volatility value may be identified based on an image signal input to the electronic device.

In one or more embodiments, the speaker disposed adjacent to the first device may be disposed on a first side surface of a second device among the at least two devices, and the first side surface of the second device may be a surface facing the first device.

In one or more embodiments, a sound channel of speakers positioned in a first direction from a central point among speakers of the at least two devices may include a first channel, a sound channel of speakers positioned in a second direction opposite to the first direction from the central point among the speakers of the at least two devices may include a second channel, and the central point may include a central point of the at least two devices.

In one or more embodiments, sound intensity of the first device may be increased by a first value, sound intensity of the second device is increased by a second value, and the first value may have a value greater than the second value.

In one or more embodiments, the operation for identifying that the extended display function of at least two devices among the plurality of display devices and the electronic device is activated may include, in response to identifying that the at least two devices are physically connected through at least one hinge, an operation for identifying that the extended display function of the at least two devices is activated.

In one or more embodiments, the method of operating an electronic device may include an operation for identifying frames of a screen displayed on the at least two devices. In one or more embodiments, the method of operating an electronic device may include an operation for measuring a difference in pixel values of the frames. In one or more embodiments, the method of operating an electronic device may include an operation for identifying the volatility value of the at least two devices.

In one or more embodiments, the method of operating an electronic device may include an operation for identifying the volatility value of the at least two devices based on an area where an object displayed on a screen of the at least two devices is positioned.

In one or more embodiments, the operation for increasing sound intensity of speakers of a first device having a largest volatility value among the at least two devices may include an operation for increasing sound intensity of a speaker corresponding to an area where the object is positioned.

An electronic device connected to a plurality of display devices according to one or more embodiments of the disclosure may include at least two speakers and a processor connected to the at least two speakers. In one or more embodiments, the processor may identify that an extended display function of at least two devices among the plurality of display devices and the electronic device is activated. In one or more embodiments, it may increase the sound intensity of speakers of a first device having a largest volatility value among the at least two devices. In one or more embodiments, it may increase the sound intensity of a speaker disposed adjacent to the first device. In one or more embodiments, the volatility value may indicate a degree of screen change of the at least two devices. In one or more embodiments, the volatility value may be identified based on an image signal input to the electronic device.

In one or more embodiments, the speaker disposed adjacent to the first device is disposed on a first side surface of a second device among the at least two devices, and the first side surface of the second device may include a surface facing the first device.

In one or more embodiments, a sound channel of speakers positioned in a first direction from a central point among speakers of the at least two devices may include a first channel. In one or more embodiments, a sound channel of speakers positioned in a second direction opposite to the first direction from the central point among the speakers of the at least two devices may include a second channel. In one or more embodiments, the central point may include a central point of the at least two devices.

In one or more embodiments, sound intensity of the first device may be increased by a first value, sound intensity of the second device is increased by a second value, and the first value may have a value greater than the second value.

In one or more embodiments, an electronic device further includes a connector connected to the processor, and the processor may be configured to, in response to identifying that the at least two devices are physically connected through at least one connector, identify that the extended display function of the at least two devices is activated.

In one or more embodiments, the processor may identify frames of a screen displayed on the at least two devices. In one or more embodiments, the processor may be configured to measure a difference in pixel values of the frames.

In one or more embodiments, the processor may be configured to identify an area where an object displayed on a screen of the at least two devices is positioned.

In one or more embodiments, the processor may be configured to increase sound intensity of a speaker corresponding to the area where the object is positioned.

In a non-transitory recording medium storing computer-readable instructions according to one or more embodiments of the disclosure, the instructions, when executed by at least one processor of an electronic device, may include an operation for identifying that an extended display function of at least two devices among a plurality of display devices and the electronic device is activated. The instructions, when executed by at least one processor of an electronic device, may include an operation for increasing sound intensity of speakers of a first device having a largest volatility value among the at least two devices. The instructions, when executed by at least one processor of an electronic device, may perform an operation for increasing sound intensity of a speaker disposed adjacent to the first device. In one or more embodiments, the volatility value may indicate a degree of screen change of the at least two devices. In one or more embodiments, the volatility value may be identified based on an image signal input to the electronic device.

In one or more embodiments, the speaker disposed adjacent to the first device may be disposed on a first side surface of a second device among the at least two devices. In one or more embodiments, the first side surface of the second device may include a surface facing the first device.

In one or more embodiments, a sound channel of speakers positioned in a first direction from a central point among speakers of the at least two devices may include a first channel. In one or more embodiments, a sound channel of speakers positioned in a second direction opposite to the first direction from the central point among the speakers of the at least two devices may include a second channel. In one or more embodiments, the central point may include a central point of the at least two devices.

In one or more embodiments, sound intensity of the first device may be increased by a first value, sound intensity of the second device is increased by a second value, and the first value may have a value greater than the second value.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. The electronic device according to embodiments of the disclosure is not limited to the above-described devices.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to one or more embodiments, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the server device 520 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two user equipments (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method of operating an electronic device connected to a plurality of display devices, the method comprising:
identifying that an extended display function of at least two devices among the plurality of display devices and the electronic device is activated;
identifying a volatility value for each device of the at least two devices based on an input signal input to the electronic device;
increasing a sound intensity of speakers of a first device having a largest volatility value among the at least two devices; and
increasing a sound intensity of a speaker disposed adjacent to the first device,
wherein each volatility value for each device of the at least two devices indicates a degree of a screen change of the device.

2. The method of claim 1, wherein the speaker disposed adjacent to the first device is disposed on a first side surface of a second device among the at least two devices, and
wherein the first side surface of the second device comprises a surface facing the first device.

3. The method of claim 2, wherein speakers positioned in a first direction from a central point among speakers of the at least two devices are configured to output sound corresponding to a left channel of the input signal, and
wherein speakers positioned in a second direction opposite to the first direction from the central point among the speakers of the at least two devices are configured to output sound corresponding to a right channel of the input signal, and wherein the central point includes a central point of the at least two devices.

4. The method of claim 3, wherein the sound intensity of the speakers of the first device is increased by a first value,
wherein the sound intensity of the speaker disposed adjacent to the first device is increased by a second value, and
wherein the first value is greater than the second value.

5. The method of claim 1, wherein the identifying that the extended display function of at least two devices among the plurality of display devices and the electronic device is activated comprises:
identifying that each of the at least two devices are physically connected through at least one hinge; and
based on identifying that each of the at least two devices are physically connected through the at least one hinge, identifying that the extended display function of the at least two devices is activated.

6. The method of claim 5, further comprising:
identifying frames of a screen displayed on the at least two devices; and
measuring a difference in pixel values of the frames.

7. The method of claim 1, wherein the identifying the volatility value for each device of the at least two devices comprises identifying the volatility value for each device of the at least two devices based on an area where an object displayed on a screen of the at least two devices is positioned.

8. The method of claim 7, wherein the increasing the sound intensity of the speakers of the first device comprises increasing a sound intensity of a speaker among the speakers of the first device corresponding to the area where the object is positioned.

9. An electronic device connected to a plurality of display devices, comprising:
at least two speakers;
memory storing instructions; and
at least one processor operatively connected to the memory and the at least two speakers,
wherein the instructions, when executed by the at least one processor individually or collectively, cause the electronic device to:
identify that at least two devices among the plurality of display devices and the electronic device are in an extended display mode;
identify a volatility value for each device of the at least two devices based on an input signal input to the electronic device;
increase a sound intensity of speakers of a first device having a largest volatility value among the at least two devices; and
increase a sound intensity of a speaker disposed adjacent to the first device, and
wherein each volatility value for each device of the at least two devices indicates a degree of a screen change of the device.

10. The electronic device of claim 9, wherein the speaker disposed adjacent to the first device is disposed on a first side surface of a second device among the at least two devices, and
wherein the first side surface of the second device is a surface facing the first device.

11. The electronic device of claim 9, wherein speakers positioned in a first direction from a central point among speakers of the at least two devices are configured to output sound corresponding to a left channel of the input signal,
wherein speakers positioned in a second direction opposite to the first direction from the central point among the speakers of the at least two devices are configured to output sound corresponding to a right channel of the input signal, and wherein the central point is a central point of the at least two devices.

12. The electronic device of claim 11, wherein the sound intensity of the speakers of the first device is increased by a first value,
wherein the sound intensity of the speaker disposed adjacent to the first device is increased by a second value, and
wherein the first value is greater than the second value.

13. The electronic device of claim 12, further comprising a connector connected to the at least one processor,
wherein the instructions, when executed by the at least one processor individually or collectively, cause the electronic device to:
identify that each of device of the at least two devices are physically connected through at least one hinge; and
based on each device of the at least two devices being physically connected through the at least one hinge, identify that an extended display function of the at least two devices is activated.

14. The electronic device of claim 13, wherein the instructions, when executed by the at least one processor individually or collectively, cause the electronic device to:
identify frames of a screen displayed on the at least two devices; and
measure a difference in pixel values of the frames.

15. The electronic device of claim 9, wherein the instructions, when executed by the at least one processor individually or collectively, cause the electronic device to:
identify an area where an object displayed on a screen of the at least two devices is positioned, and
increase a sound intensity of a speaker among the speakers of the first device corresponding to the area where the object is positioned.

16. The method of claim 1, wherein the identifying the volatility value for each device of the at least two devices comprises identifying a refresh rate and a frame rate of each device of the at least two devices.

17. The method of claim 1, further comprising:
identifying a display mode of each of the plurality of display devices, wherein the display mode indicates an extended display mode or a standalone display mode, and the extended display function is indicative of the extended display mode; and
based on the identifying the display mode of each of the plurality of display devices, controlling each display device of the plurality of display devices to output sound based on a single input source or a different type of input source.

18. The method of claim 1, further comprising:
comparing the volatility value of each device of the at least two devices; and
based on the comparing the volatility value of each device of the at least two devices, identifying the first device having the largest volatility value.

19. The electronic device of claim 9, wherein the instructions, when executed by the at least one processor individually or collectively, cause the electronic device to:
compare the volatility value of each device of the at least two devices; and
based on the volatility value of each device of the at least two devices being compared, identify the first device having the largest volatility value.

20. A non-transitory computer-readable storage medium having stored thereon instructions that, when executed by at least one processor of an electronic device, cause the electronic device to:
identify that at least two devices among a plurality of display devices and the electronic device are in an extended display mode;
identify a volatility value for each device of the at least two devices based on an input signal input to the electronic device;
increase sound intensity of speakers of a first device having a largest volatility value among the at least two devices; and
increase sound intensity of a speaker disposed adjacent to the first device,
wherein each volatility value for each device of the at least two devices indicates a degree of a screen change of the device.
